(19) United States
(12) Patent Application Publication
(10) Pub. No.: US 2006/0270405 A1
(43) Pub. Date: Nov. 30, 2006

(54) Method and system for database content security in directory assistance & information services systems

(76) Inventors: Mary Ann Brem, Sandycove (IE); Frank A. Vallone, Victor, NY (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/499,236

(22) Filed: Aug. 3, 2006

Related U.S. Application Data
(63) Continuation of application No. 10/328,295, filed on Dec. 23, 2002.

(51) Int. Cl. H04Q 7/20

(52) U.S. Cl. 455/432.3

(57) ABSTRACT

A Mobile Subscriber Directory Assistance (MSDA) system including originating carrier center initiating a directory assistance call, a directory assistance center providing a directory assistance service, and a search environment. The search environment includes an aggregated pointer database and at least one directory number resolution database. A caller requesting a telephone number is connected to a directory assistance service center where search criteria for the requested number are taken. The requested number is identified by searching the aggregated pointer database and the directory number resolution database. The caller is connected to the identified telephone number without releasing this identified telephone number.

### BACKGROUND

The invention relates to a field of wireless directory assistance.

Directory assistance is the service of providing a customer a telephone number for a party specified by the customer. The customer may supply a name and a city location of the party to the directory assistance operator, and the operator then looks up that party's telephone number in a computer database and provides the telephone number to the customer. Most recently, the operator, upon locating the telephone number, would activate a pre-recorded voice announcement to convey the telephone number to the customer. Some directory service providers further offer to connect the customer to the telephone number for a predetermined fee.

Currently, directory assistance service, provided for example through the 411 service, is offered by wireless and landline carriers and executed by a variety of directory assistance service providers. Providers retrieve their landline information from publicly available, federally mandated white page listings. However, for wireless listings, there is no publicly available database and no federal mandate. The information necessary to create a wireless directory resides in billing systems of various wireless carriers. Consequently, no wireless carrier can offer a comprehensive solution alone.

In order to search for a wireless phone number, current directory assistance services envision either a centralized or a distributed data model of Mobile Subscriber Directory Assistance (MSDA) service solutions. Either model is practical for a situation where a comprehensive set of data is available for carrying out the service. However, when compared, the models have certain mutually exclusive advantages that serve as determining factors when selecting the appropriate model to employ for a specific service.

Typically, a state of the art solution assumes that a comprehensive set of the data required for the service is maintained in either a centralized or distributed fashion. The decision of which model to employ depends on several considerations including the priority and requirements of the service; the availability, location, sensitivity, and survivability of the data source; and commercial considerations of the parties involved with delivering the service.

Centralized data models provide for benefits in data aggregation, search engine efficiency, and economies of scale. As shown in FIG. 1a, use of a centralized data model presumes that a large quantity of information is stored in a single location. Because of this centralized data storage facilities, network equipment, server capacity, and data storage equipment can be used more efficiently. The efficiency of the directory search engine can also be readily optimized where a comprehensive data set is available in a central repository. As shown in FIG. 1b, data may be aggregated from various external data sources. The steps required for aggregating data from multiple sources, i.e., the functions required to filter, cleanse, merge, and sort information, become more efficient when the result of the aggregation process is a centralized, inclusive data repository.

Distributed data search models are employed where there is a need for independent operational control of the data source (i.e., provisioning, updates, maintenance, etc), and when the data or a portion of the data is considered sensitive, confidential, or subject to expectation or legislation of privacy. As shown in FIG. 2, distributed data search models typically include multiple, geographically dispersed replicas of the same, comprehensive set of data, and are, therefore, more appropriate when geographic redundancy is desired for disaster resilience and recovery.

Because of the nature of a wireless Directory Assistance (DA) service utilizing a mobile subscriber database, neither a centralized nor a distributed data model alone can meet the requirements of the service. Several independent carriers concurrently provide mobile communication services in any given geographic area. For instance, there are at least four mobile communications carriers in a typical class-2 city in the United States (characterized by a population of 150,000 to 500,000 per U.S. Census data, 1998). In order to provide a viable MSDA service, each of the carriers must make their subscriber data available to the service function. From the search engine perspective, it is clear that a centralized repository of data aggregated from each of the carriers would be the preferred model.

However, because of the competitive nature of mobile communications, wireless carriers consider their subscriber data, which is in essence their list of subscribers, confidential, and are unwilling to provide their data to a third party. However, the carriers are willing to provide a third party with access to their data if that third party can guarantee the confidentiality of their subscriber information. Therefore from the commercial perspective, a distributed data model is preferred. These conflicting requirements have become significant obstacles to the creation of the MSDA service in the US.

There are certain services where conflicting requirements exist, and the use of either a centralized or distributed data model is insufficient. An example, as described for the MSDA service above, would be a call completion service where the forwarded party's telephone number is determined to be a confidential bit of information. As confidential information, the service requires that the forwarded party's number can not be exposed to the caller, the call center agent, or any component of the network that is considered to be directly interactive with a consumer of the service.

### SUMMARY OF THE INVENTION

It is an object of the present invention to realize the efficiency benefits of a centralized database, while maintaining the operational control, security, and privacy provided by distributed data models.

In accordance with one aspect of the invention, a Mobile Subscriber Directory Assistance (MSDA) system is presently provided including originating carrier center initiating a directory assistance call, a directory assistance center providing a directory assistance service, and a search environment. The search environment includes an aggregated pointer database and at least one directory number resolution database. A caller requesting a telephone number is connected to a directory assistance service center where search criteria for the requested number are taken. The requested number is identified by searching the aggregated pointer database and the directory number resolution database. The caller is connected to the identified telephone number without releasing this identified telephone number.

In accordance with another aspect of the present invention, a method for providing mobile subscriber directory assistance service is provided including connecting a caller who dials an access code for the mobile subscriber directory assistance service to a directory assistance service center; taking search criteria from the caller; searching a centralized database and at least one distributed database for a requested listing; and when the requested listing is found, connecting the caller to a subscriber of the found listing without disclosing the found telephone number.

The above advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1a is a schematic diagram of a prior art generic DA service utilizing a centralized data search model.

FIG. 1b is a schematic diagram of a prior art data aggregation function utilizing a centralized data search model.

FIG. 2 is a schematic diagram of a prior art generic DA service utilizing a distributed data search model.

FIG. 3 is a schematic diagram of MSDA service utilizing a hybrid data model, in accordance with the present invention.

FIG. 4 is a schematic diagram of a preferred embodiment of MSDA call flow.

FIG. 5 is a flow chart showing the flow of data in the DA system of the present invention;

FIG. 6 is a flow chart showing continuation of the flow of data of the flow chart of FIG. 5

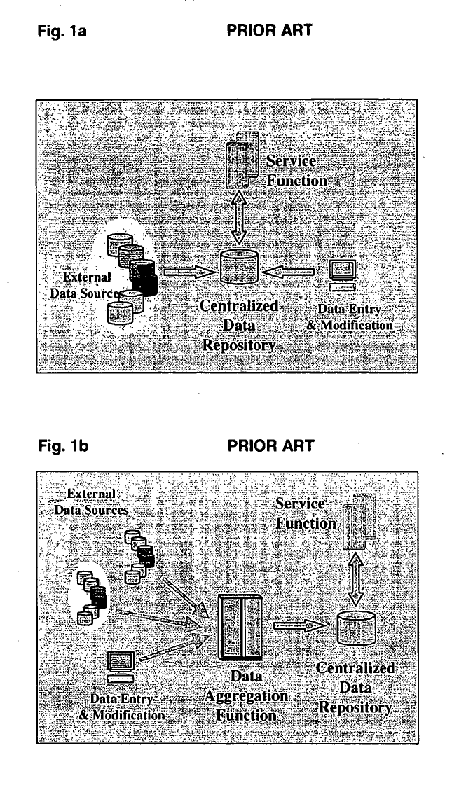

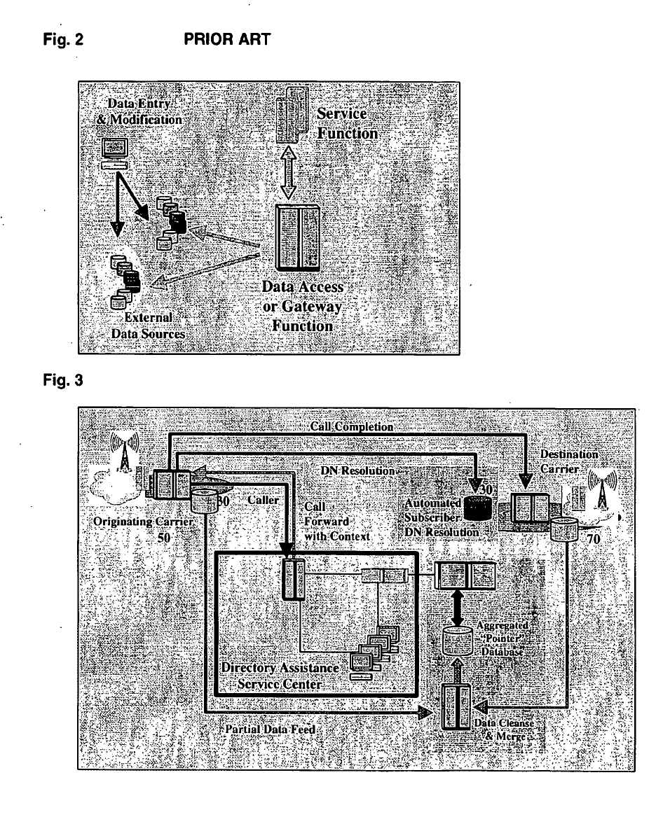

### DETAILED DESCRIPTION

In the preferred embodiment of the present invention, a hybrid data model is employed to realize the efficiency benefits of a centralized database, while maintaining the operational control, security, and privacy provided by distributed data models. This is especially important when several independent data sources are required for providing a single service, and when a portion of the content of the data sources is determined to be of a sensitive or confidential nature.

The hybrid data search model described herein makes the following assumptions:
1. Several data sources are required to deliver the envisioned service.
2. The comprehensive set of data required for delivering the service does not already exist in a centralized model.
3. The priority and efficiency requirements of the envisioned service indicate that a centralized data model is the preferred data model for the service
4. The availability, location, and sensitivity of the data make it unlikely that a centralized data model can be created in an efficient manner
5. The confidentiality and/or the expectation of privacy associated with certain portions of the data require that a distributed data search model is utilized.

As shown in FIG. 3, the preferred embodiment of the provided MSDA system includes the Mobile Subscriber Database (MSDB) 20 and the Directory Number Resolution Database (DNRDB) 30. In order to realize the described MSDA service, it is necessary to update a conventional call flow & inter-switch data communication capabilities in the call center ACD and the terrestrial portion of the mobile carrier's network.

The MSDB 20 is an aggregation of partial subscriber information from multiple carriers. The partial information stored in the MSDB includes all information necessary for a search engine to determine an individual subscriber, and preferably excludes the subscriber's telephone number. In the preferred embodiment of the MSDA system, only a pointer is included in each subscriber record stored in the MSDB. This pointer is an address embedded within the data of the MSDB that specifies the location of data, i.e., the telephone number, in another database, record or file. The pointer will facilitate downstream resolution of the subscriber's telephone number (DN or Directory Number). The MSDB 20 may be enhanced with additional personal information. The enhanced database will make it easier for customers to connect with a correct party.

The DNRDB 30 is a repository of information that correlates the pointers that are uploaded and stored in the MSDB 20 with DNs for individual subscribers. The DNRDB 30 is compiled or extracted from the same data source 70 that serves as the source of information for the MSDB. Since the DNRDB contains information that the carrier considers confidential, the DNRDB remains specific to a carrier. In the preferred embodiment, DNRDB information is not aggregated across carrier domains, and an independent DNRDB will exist for each participating carrier.

In accordance with the present invention, inter-switch data communication is updated to include two new steps for call completion in this environment. The Directory Assistance call center ACD 40 is updated to include a “call forward with context” message. The context of this message includes the network address of the destination carrier's DNRDB and the pointer information for the forward party, as determined by the MSDB. When the message is received by the originating carrier switch 50, the context will identify the destination carrier and will trigger a query to the destination carrier's DNRDB to determine the forward party's telephone number.

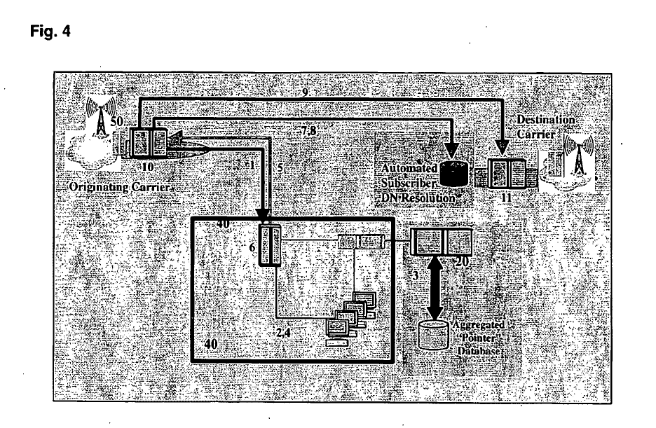

The preferred embodiment of the DA call flow is described below with reference to the accompanying FIG. 4.

As shown in FIG. 4, the caller dials an access code for the MSDA service (step 1) and is connected to an agent at the DA service center 40. The access code for the described MSDA service is preferably “422”.

The agent prompts the caller for the appropriate information and queries the MSDB to find the desired listing (step 2). As described above a search engine provided with the MSDB will preferably perform the search until the correct pointer is identified (step 3).

Once the correct listing is determined, the agent informs the caller to stay on the line and the call will be completed to the forward party. The forward party's telephone number is not available in the MSDB, so it cannot be given to the caller. The agent performs a key sequence (similar to call completion) to release the call back to the call center ACD 40 (step 4).

The call center ACD 40 then generates a “call forward with context” message, releases the call back to the originating carrier's switch (both in step 5), and generates the appropriate billing information for the MSDA service (step 6). As described above, the context includes the network address of the destination carrier's DNRDB and the pointer information for the forward party, as determined by the MSDB.

When the originating carrier switch 50 receives the “call forward with context” message, it automatically queries the DNRDB of the identified destination carrier (step 7). The destination carrier DNRDB then returns the forward party telephone number to the originating carrier switch 50 (step 8).

The originating carrier switch 50 completes the call to the forward party without releasing the forward party's telephone number to the caller (step 9). The billing information for the call completion surcharge, if appropriate, is then generated by the originating carrier switch 50 (step 10), and the appropriate billing for the forward party's airtime and roaming charges are generated by the destination carrier using conventional methods (step 11).

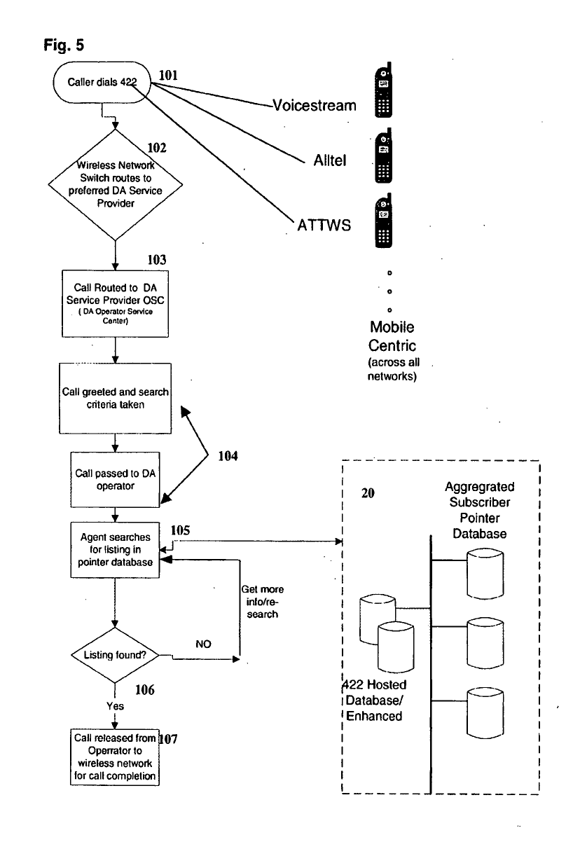

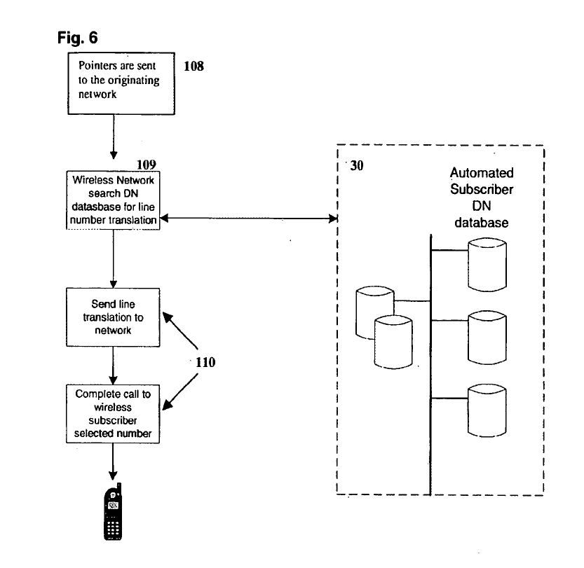

An alternative embodiment of the call flow is shown in FIGS. 5 and 6:

Step 101: Caller dials an access code for the MSDA service, preferably “422”. It is a wireless network carrier's responsibility to convey the directory assistance call to a DA service provider over the existing network

Step 102: The wireless network carrier will route the call to their preferred DA service provider.

Step 103: Each DA service provider preferably has multiple operator service centers (“OSC”). The call is routed to the OSC designated for the call from the information passed by the network.

Step 104: DA operator greets the caller and takes search criteria. Caller is preferably prompted for name address, locality and any affinity information that will assist in locating a unique directory listing.

Step 105: DA operator or automated system searches MSDB 20 for listing/pointer corresponding to the forward party requested by caller.

Step 106: Requested listing/pointer is identified without any display of telephone numbers.

Step 107: DA operator releases the call to system for call completion.

Step 108: Listing/pointer information identifying the destination carrier and information necessary to find the requested telephone number is sent to the originating network.

Step 109: Network carrier switch performs look-up on destination carrier's DNRDB 30 to retrieve the line number to complete the call.

Step 110: Call is completed without releasing the telephone number of the destination party.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

What is claimed is:

1. A mobile subscriber directory assistance system comprising:
means for receiving a directory assistance call;
means for providing a directory assistance service;
means for completing said directory assistance call without releasing a requested telephone number and without providing said requested telephone number to an operator of said directory assistance service; and
a search environment, wherein said search environment further comprises an aggregated pointer database and at least one directory number resolution database, and wherein said means for completing said directory assistance call further comprises a pointer means associated with said requested telephone number, said pointer means being configured to establish a connection to said requested telephone number without displaying and without releasing said requested telephone number.

2. The mobile subscriber directory assistance system according to claim 1, wherein said at least one directory number resolution database resides on a wireless carrier's network.

3. The mobile subscriber directory assistance system according to claim 1, wherein said at least one directory number resolution database comprises a search engine.

4. The mobile subscriber directory assistance system according to claim 1, wherein said at least one directory number resolution database comprises wireless telephone numbers.

5. The mobile subscriber directory assistance system according to claim 1, wherein said aggregated pointer database further comprises a plurality of pointers, each of said pointers being an address specifying a location of said requested telephone number.

6. The mobile subscriber directory assistance system according to claim 1, wherein said aggregated pointer database comprises a search engine.

7. A method of providing mobile subscriber directory assistance service comprising:
connecting a caller who dials an access code for the mobile subscriber directory assistance service to a directory assistance service center;
receiving search criteria from the caller;
searching an aggregated pointer database for a pointer identifying a location of a requested telephone number;
identifying said requested telephone number without providing said requested telephone number to an operator of said directory assistance service by using said pointer to search at least one directory number resolution database;
releasing said pointer to said caller to complete the call; and
connecting the caller to said identified telephone number using said pointer without releasing said identified telephone number and without displaying said identified telephone number to said operator of said directory assistance service.

8. The method of providing mobile subscriber directory assistance service according to claim 7, wherein said at least one directory number resolution database resides on a wireless carrier's network.

9. The method of providing mobile subscriber directory assistance service according to claim 7, wherein said at least one directory number resolution database comprises a search engine.

10. The method of providing mobile subscriber directory assistance service according to claim 7, wherein said aggregated pointer database further comprises a plurality of pointers, each of said pointers being an address specifying a location of said requested telephone number.

11. The method of providing mobile subscriber directory assistance service according to claim 7, wherein said aggregated pointer database comprises a search engine.

12. The method of providing mobile subscriber directory assistance service according to claim 7, further comprising a step of generating appropriate billing after connecting the caller to said identified telephone number.

13. A method of providing mobile subscriber directory assistance service comprising:
connecting a caller to a directory assistance service center;
receiving search criteria for a requested telephone number from the caller;
identifying a pointer associated with said requested telephone number without providing said requested telephone number to an operator of said directory assistance service; and
connecting the caller to said requested telephone number using said identified pointer without releasing said requested telephone number.

14. The method of providing mobile subscriber directory assistance service according to claim 13, wherein said pointer comprises a step of searching an aggregated pointer database for a pointer identifying a location of said requested telephone number.

15. The method of providing mobile subscriber directory assistance service according to claim 14, further comprising a step of identifying said requested telephone number without displaying said requested telephone number by using said pointer to search at least one directory number resolution database.

16. A mobile subscriber directory assistance system comprising:
means for connecting a caller to a directory assistance service center;
means for receiving search criteria for a requested telephone number from the caller;
means for identifying a pointer associated with said requested telephone number without providing said requested telephone number to an operator of said directory assistance service; and
means for connecting the caller to said requested telephone number using said identified pointer without releasing said requested telephone number.

17. The mobile subscriber directory assistance system according to claim 16, further comprising an aggregated pointer database.

18. The mobile subscriber directory assistance system according to claim 17, wherein said aggregated pointer database further comprises a plurality of said pointers, each of said pointers being an address specifying a location of said requested telephone number.

19. The mobile subscriber directory assistance system according to claim 17, wherein said aggregated pointer database comprises a search engine.

20. The mobile subscriber directory assistance system according to claim 16, further comprising at least one directory number resolution database.

21. The mobile subscriber directory assistance system according to claim 20, wherein said at least one directory number resolution database resides on a wireless carrier's network.

22. The mobile subscriber directory assistance system according to claim 20, wherein said at least one directory number resolution database comprises a search engine.

23. The mobile subscriber directory assistance system according to claim 20, wherein said at least one directory number resolution database comprises wireless telephone numbers.
